(19) United States
(12) Patent Application Publication
(10) Pub. No.: US 2016/0259891 A1
(43) Pub. Date: Sep. 8, 2016

(54) TELEHEALTH CARE SYSTEM

(71) Applicant: Quanta Computer Inc., Taoyuan City (TW)

(72) Inventors: Rong-Quen CHEN, Taoyuan City (TW); Chun-Hsiung FANG, Taoyuan City (TW); Kai-Ju CHENG, Taoyuan City (TW); Chen-Che HUANG, Taoyuan City (TW); Chia-Han WU, Taoyuan City (TW); Chia-Hua HU, Taoyuan City (TW); Li-An CHUANG, Taoyuan City (TW); Hsin-Lun HSIEH, Taoyuan City (TW)

(73) Assignee: QUANTA COMPUTER INC., Taoyuan City (TW)

(21) Appl. No.: 14/734,617

(22) Filed: Jun. 9, 2015

(30) Foreign Application Priority Data
Mar. 6, 2015 (TW) 104107219

(51) Int. Cl. G06F 19/00

(52) U.S. Cl. CPC G06F 19/322

(57) ABSTRACT

A telehealth care system is configured to provide a first service, in which the first service includes a first operation and a second operation. The telehealth care system includes a first host terminal, first electronic devices, and a central data center. The first electronic devices are configured to correspond to the first host terminal. The central data center is connected to the first host terminal and the first electronic devices. The first electronic devices are configured to perform the first operation via the central data center, and to perform the second operation via the first host terminal. The data processed by the first operation has a first data attribute, the data processed by the second operation has a second data attribute that is different from the first data attribute.

This application claims priority to Taiwan Application Serial Number 104107219, filed Mar. 6, 2015, which is herein incorporated by reference.

### BACKGROUND

1. Technical Field

The present disclosure relates to a cloud service. More particularly, the present disclosure relates to a telehealth care system with distribution function according to different data attributes.

2. Description of Related Art

With the development of technology, various cloud services, for example, cloud music service and cloud data transition, has become increasingly popular.

In recent years, to solve issues of elderly care, telehealth care services have got more and more attention. Therefore, with the cloud services, physiology parameters or vital sign data of patients or users can be reported back to the cloud services, and thus the patient's family or doctors are able to monitor patients' health situations.

However, in current cloud services, health care services are centrally managed by a single server, resulting in poor data processing efficiency. In addition, since privacy data of patients are reported back to the same server, the data security is reduced.

### SUMMARY

One aspect of the present disclosure provides a telehealth care system. The telehealth care system is configured to provide a first service. The first service includes a first operation and a second operation. The telehealth care system includes a first host terminal, first electronic devices and a central data center. The first electronic devices are configured corresponding to the first host terminal. The central data center is connected to the first host terminal and the first electronic devices. The first electronic devices are further configured to perform the first operation via the central data center and to perform the second operation via the first host terminal. The data processed by the first operation has a first data attribute. The data processed by the second operation has a second data attribute that is different from the first data attribute.

In summary, the telehealth care system provided in the present disclosure can process data separately according to different data attributes (e.g., the required bandwidth of service or operation corresponding to the data) or according to data privacy. Thus, the telehealth care system can have the advantage of saving bandwidth and increasing process efficiency. Further, with the modular and customized designs, various services are able to be adjusted according to requirements from customers.

### BRIEF DESCRIPTION OF THE DRAWINGS

FIG. 1 is a schematic diagram illustrating a telehealth care system in accordance with one embodiment of the present disclosure;

FIG. 2A is a schematic diagram illustrating a telehealth care system performing a video conference service in accordance with one embodiment of the present disclosure;

FIG. 2B is a schematic diagram illustrating a telehealth care system performing a video conference service in accordance with one embodiment of the present disclosure;

FIG. 3 is a schematic diagram illustrating a telehealth care system performing a personal health information service in accordance with one embodiment of the present disclosure; and

FIG. 4 is a schematic diagram illustrating a telehealth care system performing a configuration setting service in accordance with one embodiment of the present disclosure.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” etc., may be used herein to describe various elements, these elements should not be limited by these terms. These terms are used to distinguish one element from another.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

In this document, the term “coupled” may also be termed as “electrically coupled”, and the term “connected” may be termed as “electrically connected”. “Coupled” and “connected” may also be used to indicate that two or more elements cooperate or interact with each other.

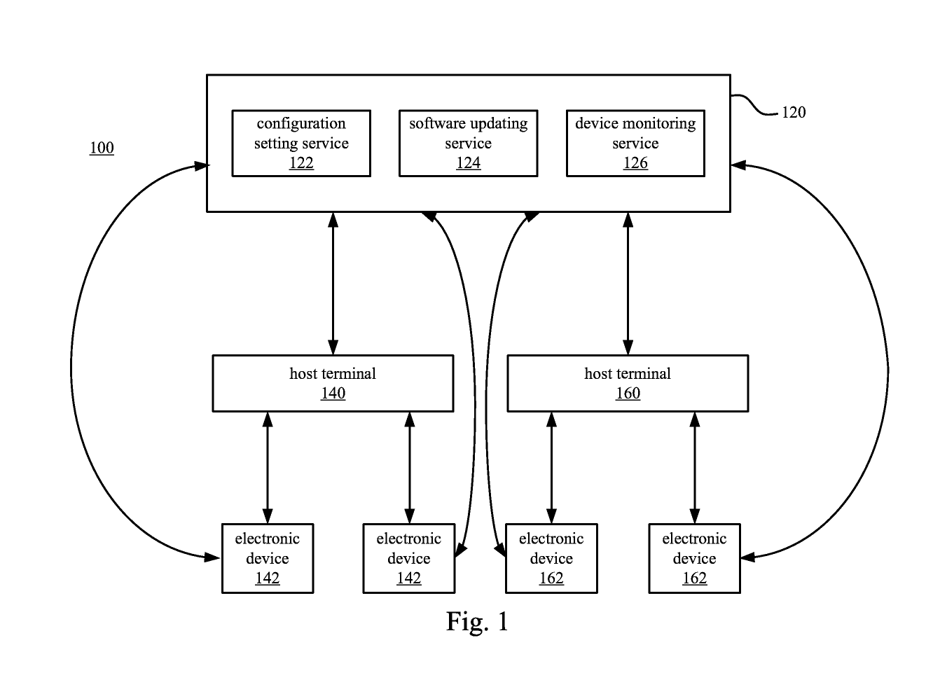

Referring to FIG. 1, FIG. 1 a schematic diagram illustrating a telehealth care system in accordance with one embodiment of the present disclosure. As shown in FIG. 1, a telehealth care system 100 includes a central data center 120, a host terminal 140, a host terminal 160, electronic devices 142, and electronic devices 162.

The central data service 120 may connect to the host terminal 140, the host terminal 160, the electronic devices 142 and the electronic devices 162 via wired network (not shown) or wireless network (not shown). In various embodiments, the central data center 120 may be configured to provide several modular services, for example, configuration setting service 122, software updating service 124, device monitoring service 126, etc.

In some embodiments, the central data service 120 sets a device configuration of each electronic device 142 and that of each electronic device 162 via the configuration setting service 122, respectively. As a result, the electronic devices 142 and the electronic devices 162 can provide users with different services or operation settings according to the respective device configurations. For example, whenever the electronic devices 142 and electronic devices 162 are booted up, the electronic devices 142 and electronic devices 162 can connect with the central data center 120 to check if there is any update, and further reset the respective device configurations via the configuration setting service 122, so as to confirm which services are able to be performed.

In some embodiments, the central data center 120 can update the electronic devices 142 and the electronic devices 162 via the software updating service 124 to update the internal software or firmware of the electronic devices 142 and those of the electronic devices 162. As a result, system versions of the electronic devices 142 and the electronic devices 162 are able to be kept being latest.

In some embodiments, the central data center 120 monitors the respective operating statuses of the electronic devices 142 and the electronic devices 162 via the device monitoring service 126 to monitor whether the electronic devices 142 and the electronic devices 162 are able to normally operate. For example, the remaining battery capacity, operated time, or network connecting statuses of the electronic device 142 or the electronic device 162 is monitored.

Each modular service described above is given for illustrative purposes only, and the present disclosure is not limited in this regard. Various add-on modular services are applicable to the central data center 120. In addition, in some embodiments, all of the modular service described above, i.e. the configuration setting service 122, the software updating service 124, and the device monitoring service 126, are performed by a single server in the central data center 120. Alternatively, in some other embodiments, each modular service described above, i.e. the configuration setting service 122, the software updating service 124, and the device monitoring service 126, is configured to be performed by different servers in the central data center 120.

In various embodiments, the host terminal 140 and the host terminal 160 correspond or be provided to different hospitals, clinics or different departments in the same hospital (e.g. hospital A, clinic B or different departments in the same hospital). The electronic devices 142 correspond to the host terminal 140, and the electronic devices 162 correspond to the host terminal 160. In the present disclosure, the host terminal 140 and the host terminal 160 can perform the same function, and the electronic devices 142 and the electronic devices 162 can also perform the same function. For simplicity, the following descriptions are described with the host terminal 140 and the electronic devices 142 as example. Related functions and operations are applicable to the host terminal 160 and the electronic devices 162, and thus the repetitious descriptions are not given here. In a specific embodiment, the host terminal 140 and the host terminal 160 can perform different functions that can be adjusted according to different requirements of hospitals.

In various embodiments, the telehealth care system 100 provides various types of services, and each service is selectively performed by the central data center 120, the host terminal 140, or the host terminal 160 according to different data attributes.

The following paragraph provides various embodiments to illustrate the function and application of the telehealth care system 100, but the present disclosure is not limited thereto.

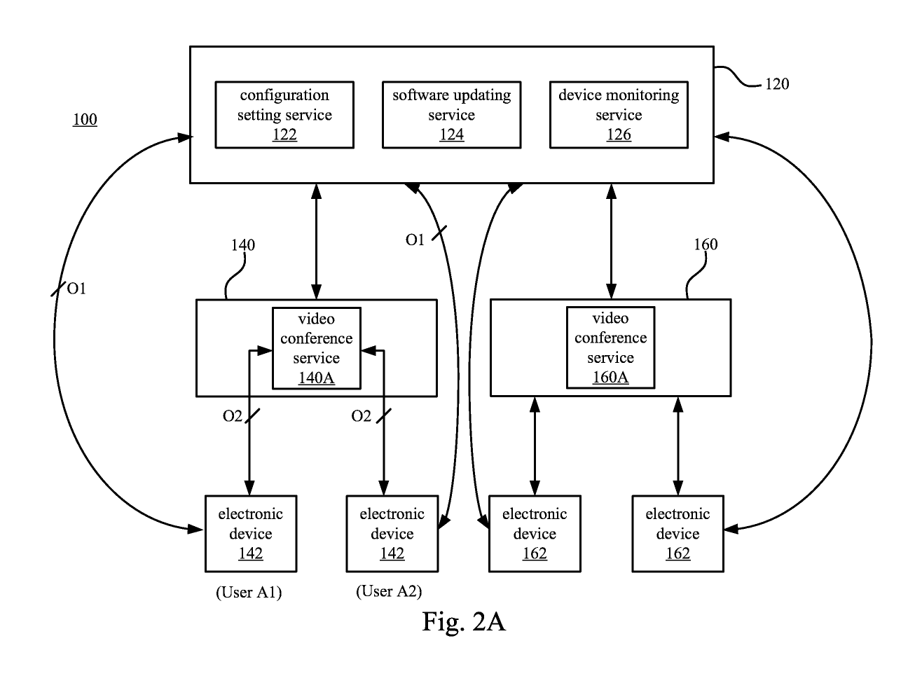

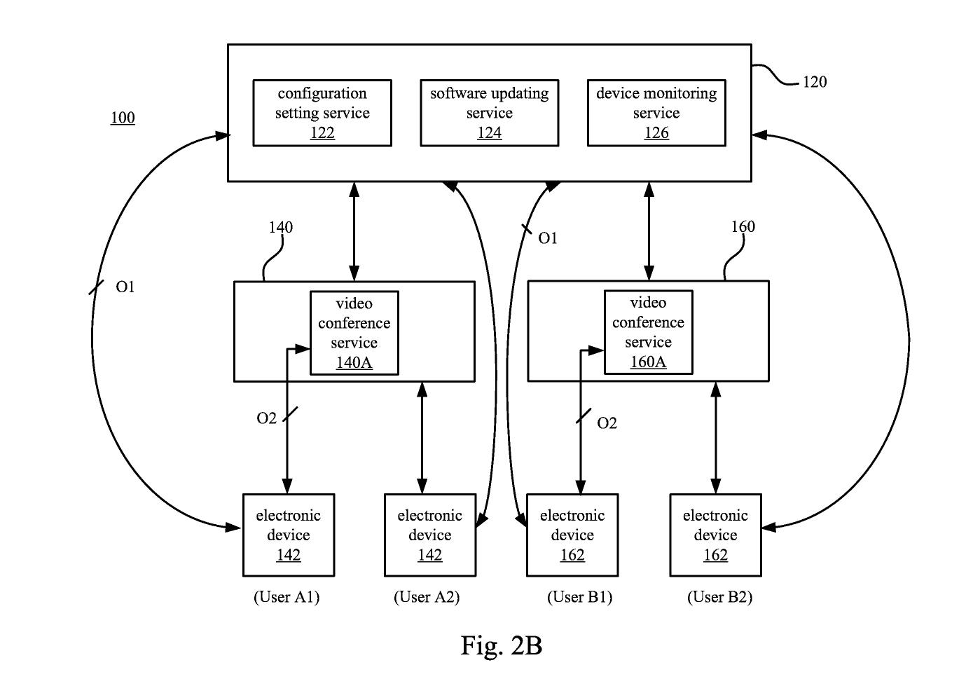

Referring to FIG. 2A, FIG. 2A is a schematic diagram illustrating a telehealth care system performing a video conference service, in accordance with one embodiment of the present disclosure. As shown in FIG. 2A, in this embodiment, the telehealth care system 100 provides a video conference service 140A via the host terminal 140, and provides a video conference service 160A via the host terminal 160.

First of all, the electronic devices 142 and the electronic devices 162 connect to the central data center 120 to set the respective device configuration via the configuration setting service 122. At the same time, the central data center 120 records information, such as Internet Protocol (IP) address or device serial number, corresponding to the electronic devices 142 and the electronic devices 162.

In this embodiment, a user or patient A1 (hereinafter referred to as user A1) of the host terminal 140 connects with another user or patient A2 (hereinafter referred to as user A2) of the same host terminal 140. In greater detail, in some embodiments, the video conference service 140A includes a communication operation O1 and a video streaming operation O2. The user A1 can connect with the central data center 120 via a corresponding electronic device 142 when the user A1 wants to have a video conference with the user A2. Accordingly, the central data center 120 performs the communication operation O1 to provide the information, such as IP address or device serial number of the electronic device 142 corresponding to the user A2. Therefore, the electronic device 142 corresponding to the user A1 can build connection with the electronic device 142 corresponding to user A2. After the central data center 120 builds the connection between the user A1 and the user A2, in order to save bandwidth of the central data center 120, the electronic device 142 corresponding to the user A1 is configured to perform the video streaming operation O2 via a server (not shown) in the host terminal 140, so as to have the video conference with the electronic device 142 corresponding to user A2.

Generally speaking, bandwidth used by the communication operation O1 is obviously lower than bandwidth used by the video streaming operation O2. In other words, with the arrangement described above, the central data center 120 only has to process the communication operation O1 with lower bandwidth, and the host terminal 140 processes the video streaming operation O2 with higher bandwidth. As a result, the telehealth care system 100 can achieve the design of bandwidth distribution. Thus, the data traffic processed by the central data center 120 is reduced, and overall operation efficiency of the system is increased.

Referring to FIG. 2B, FIG. 2B is a schematic diagram illustrating a telehealth care system performing the video conference service, in accordance with one embodiment of the present disclosure. As shown in FIG. 2B, compared with FIG. 2A, in this embodiment, the user A1 among the host terminal 140 can connect with another user or patient B1 (hereinafter referred to as the user B1) among another host terminal 160 via the video conference service 140A. For example, medical personnel in different hospitals are able to connect with each other via the aforementioned operation, so as to discuss the related cooperative matters.

Since the related operation in FIG. 2B is similar to the operation in FIG. 2A, the repetitious descriptions are not given here. As shown in FIG. 2B, in this embodiment, the video streaming operation O2 is performed via server (not shown) in the host terminal 140. In other embodiments, the video streaming operation O2 is performed via server (not shown) in the host terminal 160. The above description is given for illustrative purposes, and the present disclosure is not limited thereto.

Moreover, the above embodiments are described with video conference service as an example, and the present disclosure is not limited in this regard. Various operations or services with a higher bandwidth consumption (such as a video sharing service, a voice streaming service, or a data sharing service, etc) is performed via the host terminal 140 or the host terminal 160, so as to save the bandwidth of the central data center 120. In some embodiments, when the bandwidth used by the operations or the services with the higher bandwidth consumption exceeds a certain ratio of total bandwidth of a single server, the telehealth care system 100 immediately enables the bandwidth distribution operation described.

For example, assuming that the overall external bandwidth of the central data center 120 is about 100 megabytes (MB). When the bandwidth of the service, such as the video streaming operation O2 and the communication operation O1, used by all the electronic devices 142 exceed 80 MB, the host terminal 140 processes the video streaming operation O2 with higher bandwidth consumption. In another embodiment, when the bandwidth of the service by the host terminal 140, such as the video streaming operation O2 and the communication operation O1, used by all the electronic devices 142 exceeds 80 MB, the host terminal 160 can join the host terminal 140 to process some or all of the video streaming operation O2 with higher bandwidth consumption. The value of the overall external bandwidth of the central data center 120 and the value of the bandwidth consumption of each operation are given for illustrative purpose only, and the present disclosure is not limited thereto.

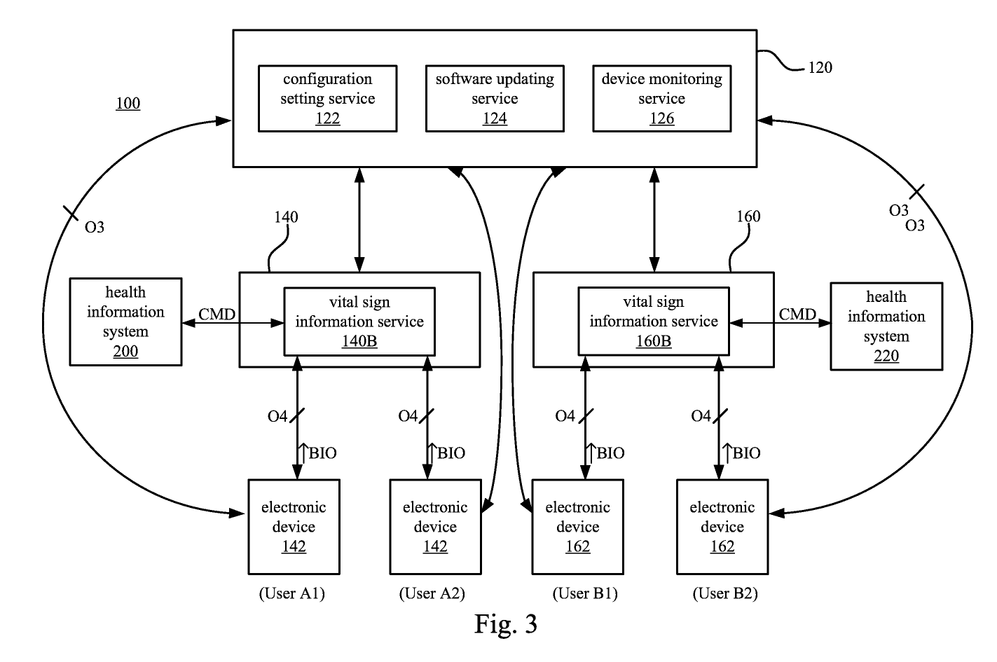

Referring to FIG. 3, FIG. 3 is a schematic diagram illustrating a telehealth care system performing a personal health information service in accordance with one embodiment of the present disclosure.

In various embodiments, the electronic devices 142 and the electronic devices 162 are various kinds of physiology vital sign (hereinafter “vital sign”) measuring devices for measuring users' vital sign data. For example, the electronic devices 142 and electronic devices 162 can be blood pressure meters, heart rate monitors, medical thermometers, multiple vital sign measurement gateway, workstations or portable vital sign measurement devices. In a specific embodiment, the electronic devices 142 and the electronic devices 162 can connect to at least one vital sign monitor device via wired or wireless connection, so as to receive vital sign information like heart rate, blood pressure, pulse, blood oxygen or blood sugar.

As shown in FIG. 3, in this embodiment, the host terminal 140 can provide a vital sign information service 140B, and the host terminal 160 can provide the vital sign information service 160B. In this embodiment, the vital sign information service 140B includes a configuration setting operation O3 and a vital sign information gathering operation O4. The electronic devices 142 and electronic devices 162 can connect with the central data center 120 via the configuration setting operation O3 in advance to set respective device configurations via the configuration setting service 122. At the same time, the central data center 120 records information, such as IP address or device serial number, corresponding to the electronic devices 142 and the electronic devices 162.

In some embodiments, as shown in FIG. 3, the host terminal 140 can perform the vital sign information gathering operation O4, and the electronic device 142 corresponding to the user A1 is thus enabled to monitor a vital sign information BIO of the user A1 (i.e. multiple vital sign parameters of the user A1), and to report back and store the vital sign information BIO in the host terminal 140. In other words, the vital sign information BIO of the user A1 is stored in certain hospital or certain clinic, instead of being stored in the remote central data center 120. As a result, the vital sign information of the user A1 are self-managed by hospital or clinic, such that the data privacy of the vital sign information BIO of the user A1 can be increased. That is, in some embodiments, the central data center 120 only has to perform operations not involving data privacy, and the host terminal 140 in hospital performs operations involving data privacy. As a result, the telehealth care system 100 can achieve bandwidth distribution according to data privacy. Thus, the data traffic processed by the central data center 120 is reduced, and overall operation efficiency of the system is increased.

Alternatively, in yet some embodiments, the vital sign information of the user A1 is reported back and stored in the central data center 120 via the vital sign information service 140B, so as to reduce management costs. The above description is given for illustrative purpose only, and those skilled in the art can adjust the arrangement of storing the vital sign information BIO according to requirements of practical applications.

Moreover, as shown in FIG. 3, the host terminal 140 further connects to a health information system 200, and the host terminal 160 further connects to a health information system 220. In various embodiments, the health information system 200 is an internal information system of the hospital or the clinic corresponding to the host terminal 140, and the health information system 220 is an internal hospital information system of hospital or clinic corresponding to the host terminal 160. Through such arrangement, medical personnel in the hospital corresponding to the host terminal 140 can output instruction CMD via the health information system 200, and access the data of the user A1 via a vital sign information service 140B, so as to obtain the vital sign data of the user A1 in real time. As a result, medical personnel can monitor each patient's vital sign situations efficiently. Meanwhile, the health information system 200 can also monitor and store each user's vital sign information via the vital sign information service 140B, and thus a highly integrated health care environment is achieved.

It is noted that, the video conference service 140A and the vital sign information service 140B could be performed via the same server (not shown) or separated servers (not shown). The above description is given for illustrative purposes only, and the present disclosure is not limited thereto.

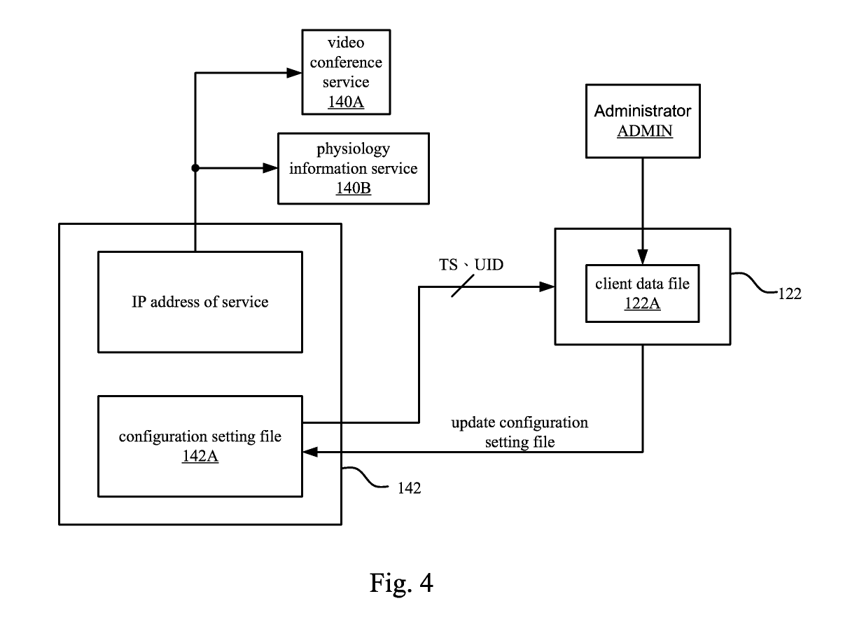

Referring to FIG. 4, FIG. 4 is a schematic diagram illustrating a telehealth care system performing a configuration setting service, in accordance with one embodiment of the present disclosure.

In various embodiments of this disclosure, after booting up, the device configurations of the electronic devices 142 and that of the electronic devices 162 are set via the configuration setting service 122 of the central data center 120.

In greater detail, as shown in FIG. 4, taking the electronic devices 142 for example, the configuration setting service 122 stores a client data file 122A (such as hospital A, clinic B or different departments in the same hospital) corresponding to each host terminal, in which the client data file 122A can be set in advance by an administrator ADMIN (such as the company which provides the telehealth care system 100). After the electronic device 142 connected with the central data center 120, the configuration setting service 122 provides a configuration setting file 142A of the electronic device 142 according to the clinic data file 122A corresponding to the host terminal 140, so as to update device setting of the electronic device 142. For example, after updating the device configuration of the electronic device 142 (e.g., the user A), the electronic device 142 is able to use the IP addresses of various services (such as the video conference service 140A or the health information service 140B described above) of the host terminal 140 (e.g., the hospital A), and thus the electronic device 142 is allowed to perform the related services. After received the configuration setting file 142A, the electronic device 142 reports information, such as timestamp TS and device serial number UID, back to the configuration setting service 122, and stores those information in the central data center 120. With the above operation, customized design for the services, employed by the electronic devices 142, is achieved via the corresponding configuration setting file 142 A and the client data file 122A.

In addition, the embodiments in the present disclosure are described with two host terminals 140 and 160, but the present disclosure is not limited thereto. Those skilled in the art can adjust or increase the number of the host terminal. Similarly, the above descriptions are described with the video conference service 140A and the vital sign information service 140B as an example, but the present disclosure is not limited thereto. Various services can be extended or adjusted accordingly in each host terminal.

In summary, the telehealth care system provided in the present disclosure can process data separately according to different data attributes (e.g., the required bandwidth of service or operation corresponding to the data) or according to data privacy. Thus, the telehealth care system can have the advantage of saving bandwidth and increasing process efficiency. Further, with the modular and customized designs, various services are able to be adjusted according to requirements from clients.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A telehealth care system is configured to provide a first service, wherein the first service comprises a first operation and a second operation, the telehealth care system comprising:
a first host terminal;
a plurality of first electronic devices configured to correspond to the first host terminal; and
a central data center connected to the first host terminal and the first electronic devices,
wherein the first electronic devices are configured to perform the first operation via the central data center and to perform the second operation via the first host terminal, wherein data processed by the first operation has a first data attribute, and data processed by the second operation has a second data attribute different from the first data attribute.

2. The telehealth care system of claim 1, wherein the first data attribute corresponds to a first bandwidth, the second data attribute corresponds to a second bandwidth, and the first bandwidth is less than the second bandwidth.

3. The telehealth care system of claim 2, wherein the first service is a video conference service, the first operation is a communication operation and the second operation is a video streaming operation, wherein a first one of the first electronic devices is configured to perform the communication operation via the central data center to connect with a second one of the first electronic devices, and the first one of the first electronic devices is further configured to perform the video streaming operation via the first host terminal to have a video conference with the second one of the first electronic devices.

4. The telehealth care system of claim 2, further comprising:
a second host terminal;
a plurality of second electronic devices configured to correspond to the second host terminal,
wherein the first service is a video conference service, the first operation is a communication operation and the second operation is a video streaming operation, wherein a first one of the first electronic devices is configured to perform the communication operation via the central data center to connect with a first one of the second electronic devices, and the first one of the first electronic devices is further configured to perform the video streaming operation to have a video conference with the first one of the second electronic devices.

5. The telehealth care system of claim 1, wherein a privacy of the second data attribute is higher than a privacy of the first data attribute, and the data having the second data attribute are stored in the first host terminal, and the data having the first data attribute are stored in the central data center.

6. The telehealth care system of claim 5, wherein the first service is a vital sign information service, the first operation is a configuration setting operation, and the second operation is a vital sign information gathering operation, wherein the first electronic devices are configured to perform the configuration setting operation via the central data center and to perform the vital sign information gathering operation via the first host terminal.

7. The telehealth care system of claim 6, wherein the first electronic devices are a plurality of vital sign data measuring devices, and the vital sign data measuring devices are configured to measure at least one vital sign information.

8. The telehealth care system of claim 7, wherein the first host terminal is connected to a health information system to monitor and store at least one vital sign information.

9. The telehealth care system of claim 1, wherein the central data center is configured to provide a configuration setting service to set a configuration setting file of each of the first electronic devices.

10. The telehealth care system of claim 1, wherein the central data center is configured to provide a software updating service to update the first electronic devices.
